(19) United States
(12) Patent Application Publication
(10) Pub. No.: US 2010/0252613 A1
(43) Pub. Date: Oct. 7, 2010

(54) DESOLDERING DEVICE AND ATTACHMENT THEREOF

(75) Inventors: ZHENG-HENG SUN, Tu-Cheng (TW); XIAO-FENG MA, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/432,713

(22) Filed: Apr. 29, 2009

(30) Foreign Application Priority Data
Apr. 2, 2009 (CN) 200910301314.4

(51) Int. Cl. B23K 3/02; B23K 3/08

(52) U.S. Cl. 228/19

(57) ABSTRACT

A desoldering device is configured for desoldering a multi-pin electronic element from a circuit board. The desoldering device includes an iron and an attachment. The attachment is attached to the iron. The attachment includes a plate. A number of through holes are defined in the plate to allow pins of the multi-pin element to extend therethrough. Heat is capable of being transmitted from the iron the plate to melt soldered tins around the pins of the multi-pin element.

### BACKGROUND

1. Technical Field

The present disclosure relates to desoldering devices, and particularly to a desoldering device with multi-pin heating attachment for desoldering and removing electronic elements from circuit boards.

2. Description of Related Art

An iron is often applied for soldering and desoldering electronic elements of circuit boards. A head of the iron is generally cone-shaped and fit for heating tins around only one pin at a time of the electronic element. Thus, it is very inconvenient to use an iron to remove multi-pin electronic elements from circuit boards.

### BRIEF DESCRIPTION OF THE DRAWINGS

FIG. 1 is an exploded, isometric view of an exemplary embodiment of a desoldering device, the desoldering device including an attachment.

FIG. 2 is an enlarged isometric, cutaway view of the attachment of FIG. 1.

FIG. 3 is an assembled, isometric view of FIG. 1.

FIG. 4 is an isometric view of the desoldering device of FIG. 1 in use on a circuit board.

### DETAILED DESCRIPTION

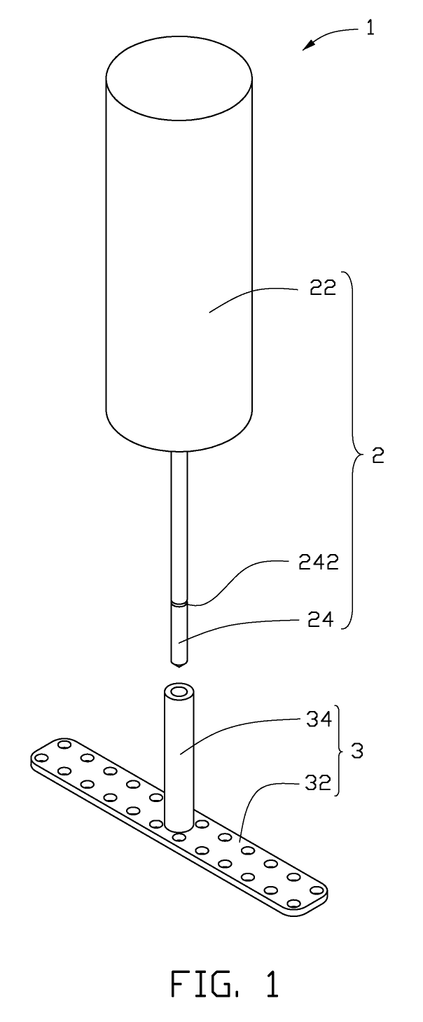

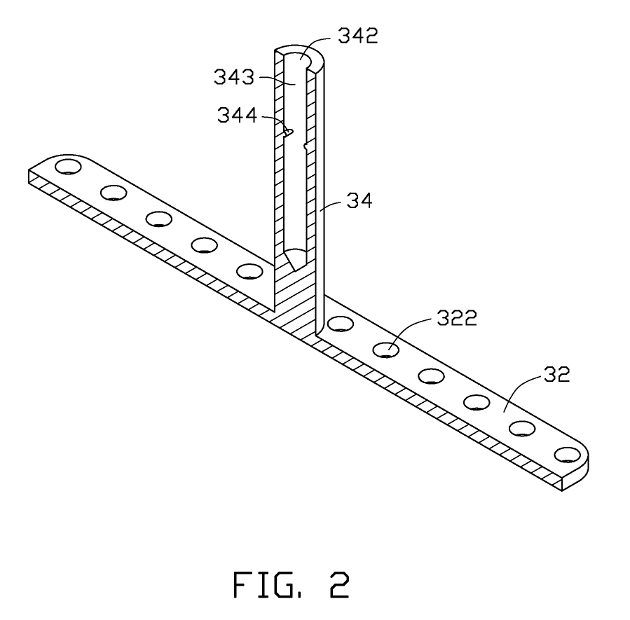

Referring to FIGS. 1 through 4, an exemplary embodiment of a desoldering device 1 is configured for desoldering a multi-pin electronic element such as a chip from a circuit board 60. The desoldering device 1 includes an iron 2 and an attachment 3 attached to the iron 2. The iron 2 includes a handle 22 and a head 24 extending from the handle 22. In one embodiment, the head 24 is cone-shaped. An annular slot 242 is defined in a circumferential surface of the head 24.

The attachment 3 is made of heat conductive materials, such as copper, and includes a plate 32 and a connection portion 34 perpendicularly extending from the plate 32. The connection portion 34 is cylinder-shaped. A cylindrical receiving space 342 is defined in the connection portion 34 to receive the head 24 of the iron 2 therein. Two opposite protrusions 344 extend from an inside wall of the connection portion 34 around the receiving space 342 to engage in the annular slot 242 of the iron 2. Two lines of through holes 322 are defined in the plate 32, corresponding to pins 50 of an electronic element. A size of each through hole 322 is greater than that of the corresponding pin 50 of the electronic element.

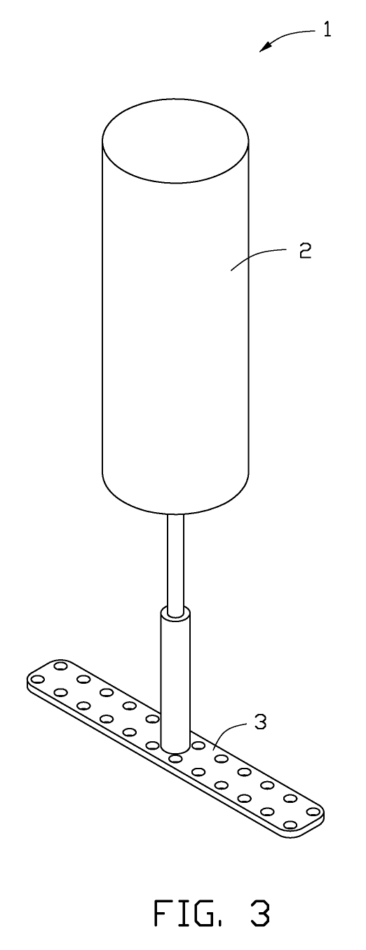

Referring to FIG. 3, in assembly, the head 24 of the iron 2 is inserted into the receiving space 342 of the attachment 3. The protrusions 344 of the attachment 3 are received in the annular slot 242 of the iron 2. Thus, the head 24 of the iron 2 is securely attached to the attachment 3.

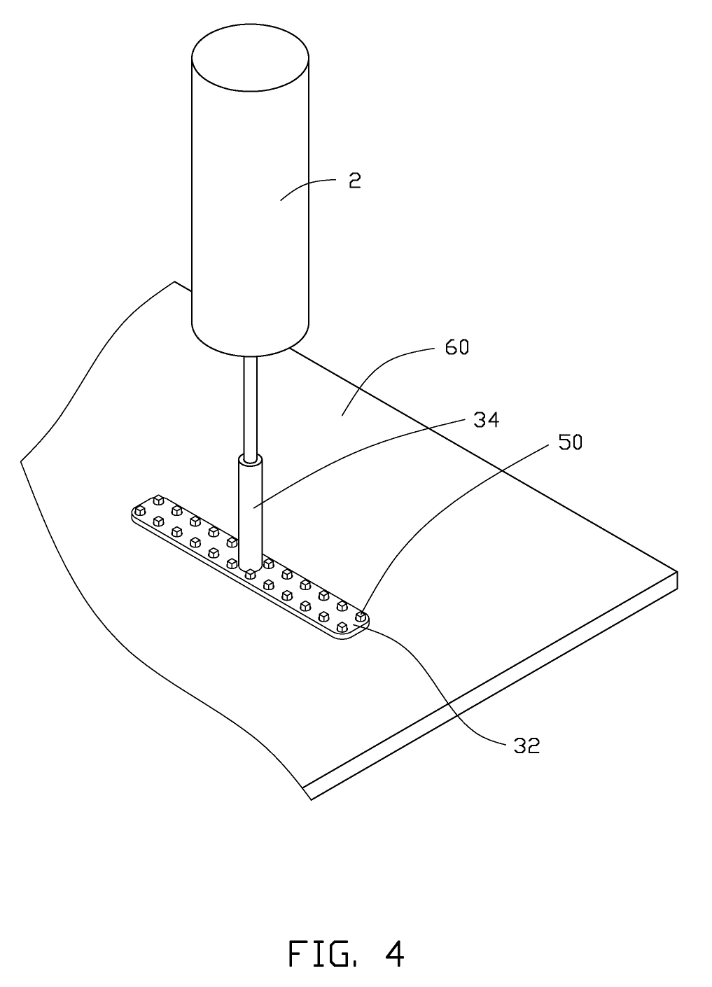

Referring also to FIG. 4, to remove multi-pin electronic elements from the circuit board 60, the plate 32 of the attachment 3 is contacted to the circuit board 60 with all exposed ends of the pins 50 of the multi-pin electronic element on the circuit board 60 extending through the through holes 322 of the attachment 3. Heat is transmitted from the head 24 of the iron 2 to the plate 32 via the connecting portion 34 of the attachment 3. Soldered tins around all the pins 50 of the electronic element are simultaneously heated to melting point. Thus, the multi-pin electronic element can be easily detached from the circuit board 60.

With the attachment 3 being detached, the head 24 of the iron 2 can be used to remove a single pin electronic element from a circuit board.

In other embodiments, two opposite slots can be defined in the inside wall of the connection portion 34 and communicate with the receiving space 342. Two opposite protrusions can extend from the head 24 of the iron 2 to engage in the two opposite slots.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the embodiments to the full extent indicated by the broad general meaning of the terms in which the appended claims are expressed.

What is claimed is:

1. A desoldering device for desoldering a multi-pin electronic element from a circuit board, comprising:
an iron; and
an attachment configured for attaching to the iron, the attachment comprising a plate;
wherein a plurality of through holes is defined in the plate to allow pins of the multi-pin electronic element to extend therethrough, heat is capable of being transmitted from the iron to the plate to melt soldered tins around the pins of the multi-pin element.

2. The desoldering device of claim 1, wherein a size of each through hole is greater than that of the corresponding pin of the multi-pin element.

3. The desoldering device of claim 1, wherein the iron comprises a handle and a head extending from the handle, the attachment further comprises a connection portion perpendicularly extending from the plate, the plate is capable of contacting the circuit board, the connection portion is for connecting with the head of the iron.

4. The desoldering device of claim 3, wherein a receiving space is defined in the connection portion to receive the head of the iron therein, two opposite protrusions extend from an inside wall of the connection portion around the receiving space, an annular slot is defined in the head to engagably receive the two opposite protrusions.

5. The desoldering device of claim 3, wherein a receiving space is defined in the connection portion to receive the head therein, two opposite slots are defined in an inside wall of the connection portion and communicate with the receiving space, two opposite protrusions extend from the head to engage in the two opposite slots.

6. An attachment for assisting an iron to desolder a multi-pin electronic element from a circuit board, comprising:
a plate; and
a connection portion extending from the plate;
wherein a plurality of through holes is defined in the plate to allow pins of the multi-pin element to extending therethrough, heat is capable of being transmitted from the iron to the plate to melt soldered tins around the pins of the multi-pin element.

7. The attachment of claim 6, wherein a size of each through hole is greater than that of the corresponding pin of the multi-pin element.

8. The attachment of claim 6, wherein a receiving space is defined in the connection portion to receive the iron, two opposite protrusions extend from an inside wall of the connection portion around the receiving space to connect with the iron.

9. The attachment of claim 6, wherein a receiving space is defined in the connection portion to receive the iron, two opposite slots are defined in an inner wall of the connection portion around the receiving space and communicate with the receiving space, to engage with the iron.

10. The attachment of claim 6, wherein the plate is rectangular, the connection portion is cylindrical and perpendicularly extends from the plate.
